(19) United States
(12) Patent Application Publication
(10) Pub. No.: US 2010/0327762 A1
(43) Pub. Date: Dec. 30, 2010

(54) Lighting device with optical pulsation suppression by polyphase-driven electric energy

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/457,998

(22) Filed: Jun. 29, 2009

(51) Int. Cl. H05B 37/02

(52) U.S. Cl. 315/228; 315/250; 315/258; 315/294

(57) ABSTRACT

The present invention relies on polyphase alternating current power with phase difference or direct current power rectified from polyphase alternating current power to drive a common electric energy-driven luminous body; or to separately drive proximately installed individual electric energy-driven luminous bodies so that the pulsation of the outwardly projected light is reduced.

### BACKGROUND OF THE INVENTION

(a) Field of the Invention

The present invention relates to a method of reducing the luminous brightness of a electric energy-driven luminous body which directly use alternating current power following the pulsation rate of the alternating current power voltage by means of polyphase-drive electric energy.

(b) Description of the Prior Art

The deficiency of traditional alternating current lamps lies in their discontinuous light optical pulsation caused by alternating current power pulsation

### SUMMARY OF THE INVENTION

The present invention relies on polyphase alternating current power with phase difference or direct current power rectified from polyphase alternating current power to drive a common electric energy-driven luminous body; or to separately drive proximately installed individual electric energy-driven luminous bodies so that the pulsation of the outwardly projected light is reduced.

### BRIEF DESCRIPTION OF THE DRAWINGS

FIG. 1 is the optical pulsation oscillogram of the traditional single phase alternating current power or alternating current full wave-rectified direct current directly driving the electric energy-driven luminous body.

FIG. 2 is the circuit diagram of the electric energy-driven luminous body individually driven by single phase power in three ways through inductor split-phase current, capacitor split-phase current and the resultant vector current of the inductor and capacitor split-phase currents.

FIG. 3 is the circuit diagram of the interchanging positions of the capacitor with the electric energy-driven luminous body and/or inductor with the electric energy-driven luminous body in FIG. 2.

FIG. 4 is the brightness oscillogram of the electric energy-driven luminous body in FIG. 2 and FIG. 3.

FIG. 5 is the circuit block diagram of the present invention in parallel with the alternating current in three ways: the capacitor in series with the electric energy-driven luminous body, the inductor in series with the electric energy-driven luminous body, and directly by the electric energy-driven luminous body or by the resistor in series with the electric energy-driven luminous body.

FIG. 6 is the circuit block diagram showing the capacitor in series with the electric energy-driven luminous body and connected in parallel directly with the electric energy-driven luminous body or with the electric energy-driven luminous body in series with the resistor in order to accept alternating current or bidirectional power drive.

FIG. 7 is the circuit block diagram showing the inductor in series with the electric energy-driven luminous body and connected in parallel directly with the electric energy-driven luminous body or with the electric energy-driven luminous body in series with the resistor in order to accept alternating current or bidirectional power drive.

FIG. 8 is the circuit block diagram showing the capacitor in series with the electric energy-driven luminous body and connected in parallel with the electric energy-driven luminous body in series with the inductor in order to accept alternating current or bidirectional power drive.

FIG. 9 is the circuit diagram of the present invention wherein three phase four wire alternating current power is driving three sets of electric energy-driven luminous bodies in Y connection.

FIG. 10 is the circuit diagram of the present invention wherein three phase alternating current power is driving three sets of electric energy-driven luminous bodies in Δ connection.

FIG. 11 is the first circuit diagram of the present invention wherein three phase alternating current power is driving two sets of electric energy-driven luminous bodies in V connection.

FIG. 12 is the second circuit diagram of the present invention wherein three phase alternating current power is driving two sets of electric energy-driven luminous bodies in V connection.

FIG. 13 is the circuit diagram showing three phase alternating current power being supplied, through the current limit devices, to the three phase full wave direct current electric energy that had been rectified by the bridge rectifier and then to the direct current electric energy-driven luminous body.

FIG. 14 is the circuit diagram showing the three phase alternating current power passing through the half-wave current limit impedance device to the three phase half-wave rectifier where rectified direct current electric energy is delivered to the direct current electric energy-driven luminous body.

FIG. 15 is the circuit diagram of the capacitor and inductor effecting split phase and then full wave rectification on the single phase power in order to drive the direct current electric energy-driven luminous body.

FIG. 16 is the circuit diagram of the capacitor and resistor effecting split phase and then full wave rectification on the single phase power in order to drive the direct current electric energy-driven luminous body.

FIG. 17 is the circuit diagram of the inductor and resistor effecting split phase and then full wave rectification on the single phase power in order to drive the direct current electric energy-driven luminous body.

FIG. 18 is the circuit diagram of the inductor, resistor and capacitor effecting split phase and then full wave rectification on the single phase power in order to drive the direct current electric energy-driven luminous body.

FIG. 19 is the circuit diagram of the inductor and resistor effecting split phase and then half wave rectification on the single phase power in order to drive the direct current electric energy-driven luminous body.

### DESCRIPTION OF MAIN COMPONENT SYMBOLS

(101), (102), (103): Electric energy-driven luminous body
(1000): Inductive impedance devices
(1011), (1012), (1021), (1022), (1031), (1032), (2011), (2012), (3011), (3012): Conductive terminals
(2000): Direct current electric energy-driven luminous body
(201): Capacitor
(3000): Three-phase bridge rectifier
(301): Inductor
(3500): Three-phase half wave rectifier
(401): Resistor
(703), (704): Rectifier diodes
(802), (803), (804): Single phase bridge rectifiers
a: Alternating Current power wave form
b: Wave form of direct current rectified from alternating current
c : Optical pulsation wave form of electric energy-driven luminous body
(I101) (I102), (I103): Current
N: Neutral line
R, S, T: Three-phase alternating current power lines
(Z10): Current limit device
(Z11): Half wave current limit impedance device

### DETAILED DESCRIPTION OF THE PREFERRED EMBODIMENTS

The deficiency of traditional alternating current lamps lies in their discontinuous light optical pulsation caused by alternating current power pulsation.

The present invention relies on polyphase alternating current power with phase difference or direct current power rectified from polyphase alternating current power to drive a common electric energy-driven luminous body; or to separately drive proximately installed individual electric energy-driven luminous bodies so that the pulsation of the outwardly projected light is reduced.

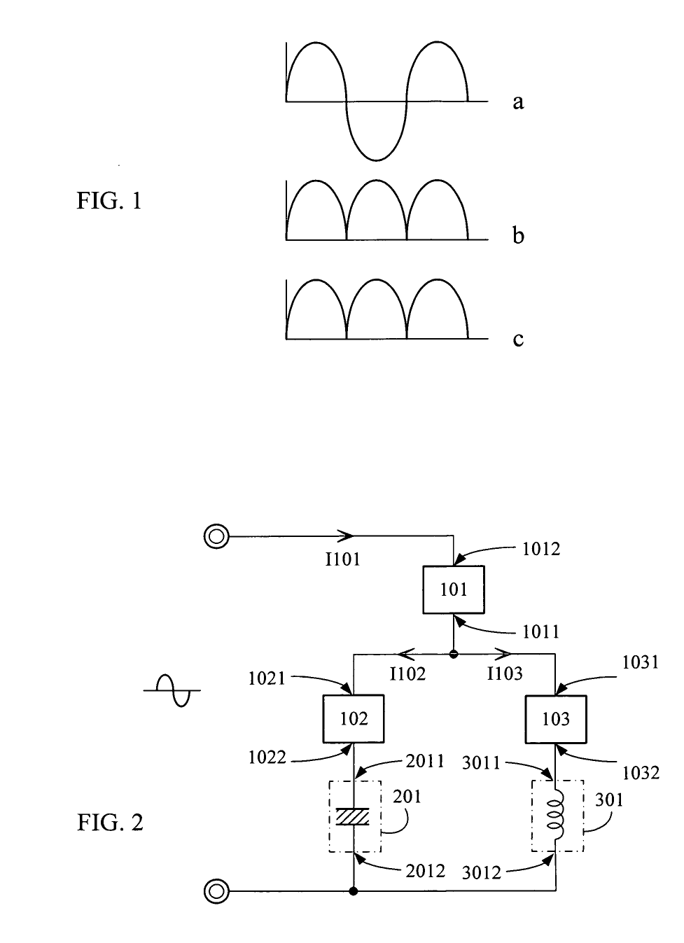

FIG. 1 is the optical pulsation oscillogram of the traditional single phase alternating current power or alternating current full wave-rectified direct current directly driving the electric energy-driven luminous body.

As shown in FIG. 1: a is alternating current power wave form; b is wave form of direct current rectified from alternating current; c is optical pulsation wave form of electric energy-driven luminous body. If the electric energy input is a bidirectional pulsating electric energy with a bidirectional non-sinusoidal wave, the improvement function is also the same.

FIG. 2 is the circuit diagram of the electric energy-driven luminous body individually driven by single phase power in three ways through inductor split-phase current, capacitor split-phase current and the resultant vector current of the inductor and capacitor split-phase currents.

As shown in FIG. 2, the components are:

The terminals (1011), (1021), and (1031) of the electric energy-driven luminous bodies (101), (102) and (103) driven by bidirectional electric energy are connected together. Terminal (1022) of the electric energy-driven luminous body (102) is connected to terminal (2011) of capacitor (201). Terminal (1032) of electric energy-driven luminous body (103) is connected to terminal (3011) of the inductor (301). Terminal (2012) of the capacitor (201) is connected to terminal (3012) of the inductor (301) after which it goes to a terminal of an alternating current or bidirectional electric energy. Terminal (1012) of electric energy-driven luminous body (101) is then connected to the other terminal of the alternating current or bidirectional electric energy, wherein the current (I101) that passes through electric energy-driven luminous body (101) is the vector sum of the current (I102) that passes through electric energy-driven luminous body (102) and current (I103) of electric energy-driven luminous body (103) which is also the total current.

Electric energy-driven luminous bodies (101), (102), (103): Are three luminous bodies integrated into one body or three proximately installed bodies consisting of gas bulbs with filaments, solid state electric energy luminous bodies such as LED and others that accept electric energy drive.

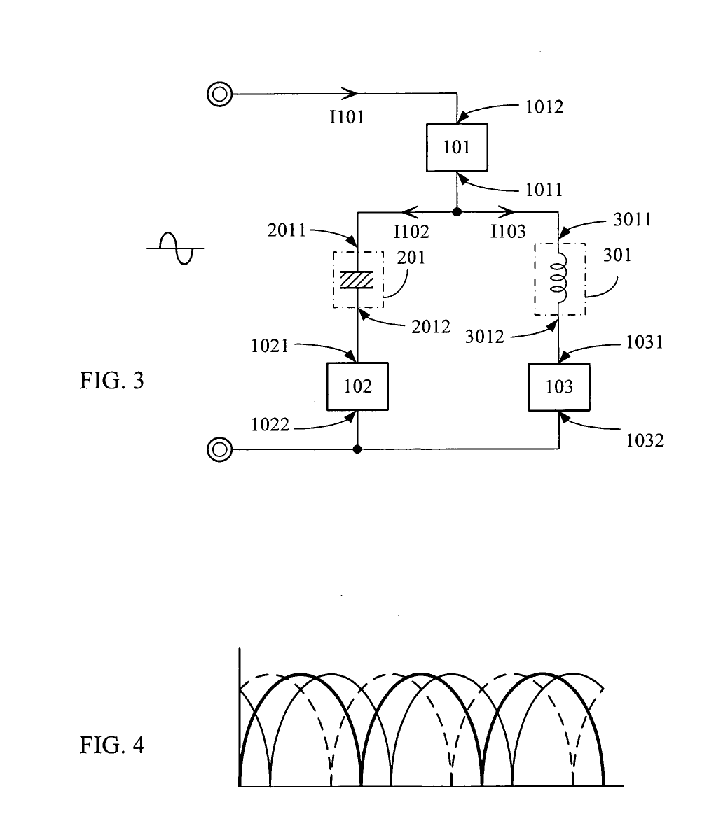

FIG. 3 is the circuit diagram of the interchanging positions of the capacitor (201) with the electric energy-driven luminous body (102) and/or inductor (301) with the electric energy-driven luminous body (103) in FIG. 2; wherein

Terminal (1011) of electric energy-driven luminous body (101), terminal (2011) of capacitor (201) and terminal (3011) of inductor (301) are connected together. The other terminal (2012) of capacitor (201) is connected to terminal (1021) of electric energy-driven luminous body (102). The other terminal (3012) of the inductor (301) is connected to terminal (1031) of the electric energy-driven luminous body (103). The other terminal (1022) of electric energy-driven luminous body (102) is connected to terminal (1032) of the electric energy-driven luminous body (103) after which it goes to a terminal of a power source. The other terminal (1012) of the electric energy-driven luminous body (101) is connected to the other terminal of the power source;

Electric energy-driven luminous bodies (101), (102), (103): Are three luminous bodies integrated into one body or three proximately installed bodies consisting of gas bulbs with filaments, solid state electric energy luminous bodies such as LED and others that accept electric energy drive;

Moreover, if series capacitor (201) or one of the electric energy-driven luminous bodies of inductor (301) is directly connected in parallel with electric energy-driven luminous body (101), or in parallel with the electric energy-driven luminous body (101) of the series resistor, then the pulsation of the projected light energy are also improved.

FIG. 4 is the brightness oscillogram of the electric energy-driven luminous bodies in FIG. 2 and FIG. 3 showing the significant reduction of their luminous pulsation.

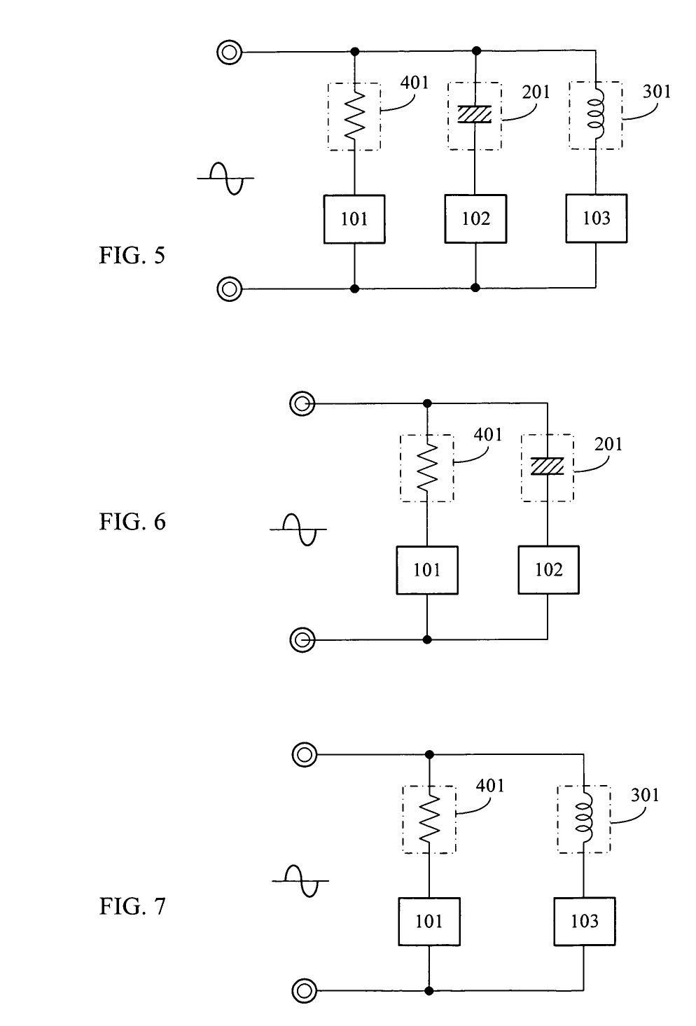

FIG. 5 is the circuit block diagram of the present invention wherein the alternating current power is in parallel with: the capacitor (201) which is in series with the electric energy-driven luminous body (102), the inductor (301) which is in series with the electric energy-driven luminous body (103), and directly with the electric energy-driven luminous body (101) or the resistor (401) which is in series with the electric energy-driven luminous body (101); as shown in FIG. 5, wherein the alternating current power is in parallel with: the capacitor (201) which is in series with the electric energy-driven luminous body (102), the inductor (301) which is in series with the electric energy-driven luminous body (103), and directly with the electric energy-driven luminous body (101) or the resistor (401) which is in series with the electric energy-driven luminous body (101).

FIG. 6 is the circuit block diagram of the present invention showing the capacitor (201) in series with the electric energy-driven luminous body (102) and connected in parallel directly with the electric energy-driven luminous body (101) or with the electric energy-driven luminous body (101) in series with the resistor (401) in order to accept alternating current or bidirectional power drive; as shown in FIG. 6, the capacitor (201) in series with the electric energy-driven luminous body (102) and connected in parallel directly with the electric energy-driven luminous body (101) or with the electric energy-driven luminous body (101) in series with the resistor (401) in order to accept alternating current or bidirectional power drive.

FIG. 7 is the circuit block diagram of the present invention showing the inductor (301) in series with the electric energy-driven luminous body (103) and connected in parallel directly with the electric energy-driven luminous body (101) or with the electric energy-driven luminous body (101) in series with the resistor (401) in order to accept alternating current or bidirectional power drive; as shown in FIG. 7, the inductor (301) in series with the electric energy-driven luminous body (103) and connected in parallel directly with the electric energy-driven luminous body (101) or with the electric energy-driven luminous body (101) in series with the resistor (401) in order to accept alternating current or bidirectional power drive.

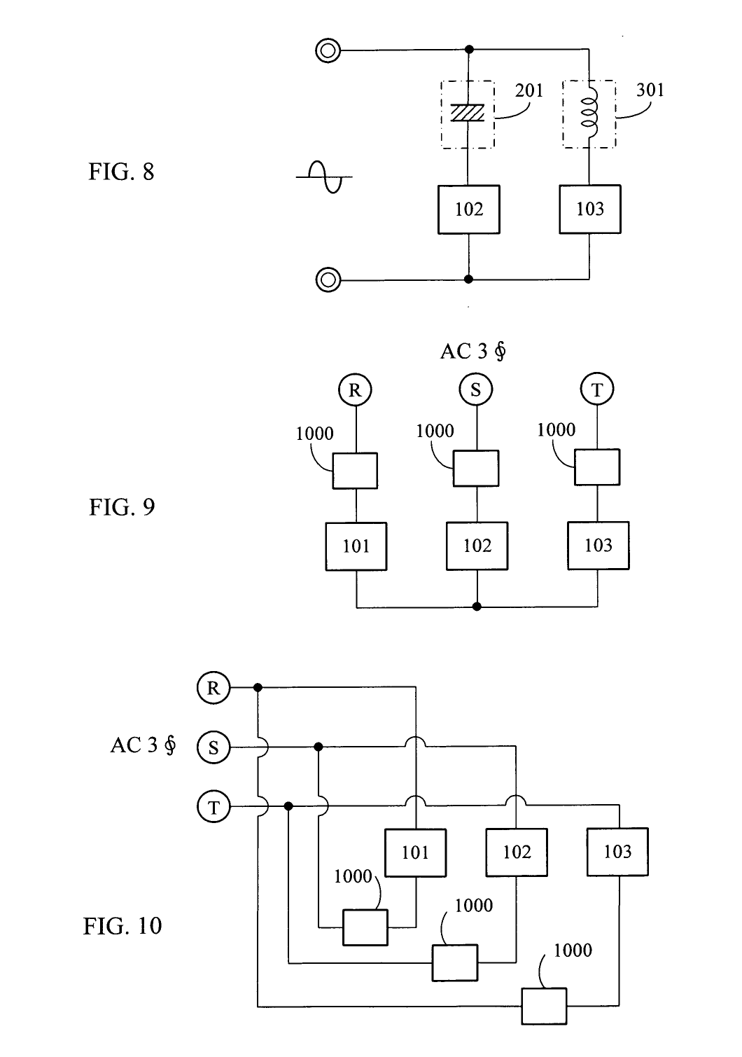

FIG. 8 is the circuit block diagram of the present invention showing the capacitor (201) in series with the electric energy-driven luminous body (102) and connected in parallel with the electric energy-driven luminous body (103) in series with the inductor (301) in order to accept alternating current or bidirectional power drive; as shown in FIG. 8, the capacitor (201) in series with the electric energy-driven luminous body (102) and connected in parallel with the electric energy-driven luminous body (103) in series with the inductor (301) in order to accept alternating current or bidirectional power drive.

The lighting device with pulsation suppression by polyphase-driven electric energy is also employ three-phase alternating current power to supply electricity to the electric energy-driven luminous body to minimize the pulsation of the luminous brightness.

FIG. 9 is the circuit diagram of the present invention wherein three phase four wire alternating current power is driving three sets of electric energy-driven luminous bodies in Y connection; as shown in FIG. 9, this consist of:

Electric energy-driven luminous body (101) which is directly connected or in series with the resistive and/or capacitive and/or inductive impedance device (1000) after which one terminal connects to a three-phase power line R, while the other terminal goes to a common Y connection point.

Electric energy-driven luminous body (102) which is directly connected or in series with the resistive and/or capacitive and/or inductive impedance device (1000) after which one terminal connects to a three-phase power line S, while the other terminal goes to a common Y connection point.

Electric energy-driven luminous body (103) which is directly connected or in series with the resistive and/or capacitive and/or inductive impedance device (1000) after which one terminal connects to a three-phase power line T, while the other terminal goes to a common Y connection point.

FIG. 10 is the circuit diagram of the present invention wherein three phase alternating current power is driving three sets of electric energy-driven luminous bodies in A connection; as shown in FIG. 10, this consist of:

Electric energy-driven luminous body (101) which is directly connected or in series with the resistive and/or capacitive and/or inductive impedance device (1000), and then in parallel between power line R and power line S.

Electric energy-driven luminous body (102) which is directly connected or in series with the resistive and/or capacitive and/or inductive impedance device (1000), and then in parallel between power line S and power line T.

Electric energy-driven luminous body (103) which is directly connected or in series with the resistive and/or capacitive and/or inductive impedance device (1000), and then in parallel between power line T and power line R.

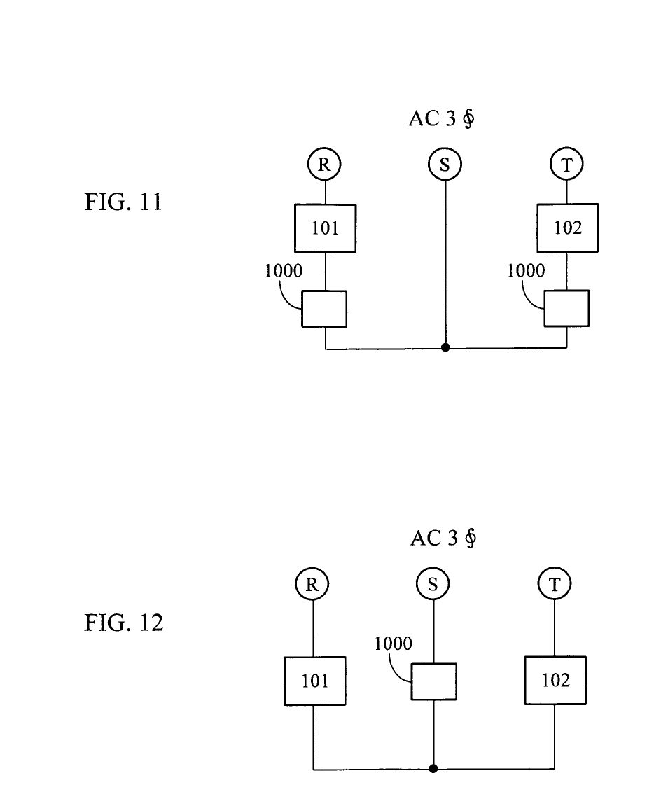

FIG. 11 is the first circuit diagram of the present invention wherein three phase alternating current power is driving two sets of electric energy-driven luminous bodies in V connection; as shown in FIG. 11, this consist of:

Electric energy-driven luminous body (101) which is directly connected or in series with the resistive and/or capacitive and/or inductive impedance device (1000), and then in parallel between power line R and power line S.

Electric energy-driven luminous body (102) which is directly connected or in series with the resistive and/or capacitive and/or inductive impedance device (1000), and then in parallel between power line S and power line T.

FIG. 12 is the second circuit diagram of the present invention wherein three phase alternating current power is driving two sets of electric energy-driven luminous bodies in V connection; as shown in FIG. 12, this consists of:

Electric energy-driven luminous body (101) which is in series with electric energy-driven luminous body (102), and then in parallel between power line R and power line T;

The power line S, after connecting in series with a resistive and/or capacitive and/or inductive impedance device (1000), is then connected to the series connection point of electric energy-driven luminous body (101) and electric energy-driven luminous body (102).

The lighting device with optical pulsation suppression by polyphase-driven electric energy further relies on direct current power rectified from polyphase alternating current power to drive a common electric energy-driven luminous body; or to separately drive proximately installed individual electric energy-driven luminous bodies so that the pulsation of the outwardly projected light is reduced. Its operation is described as the following:

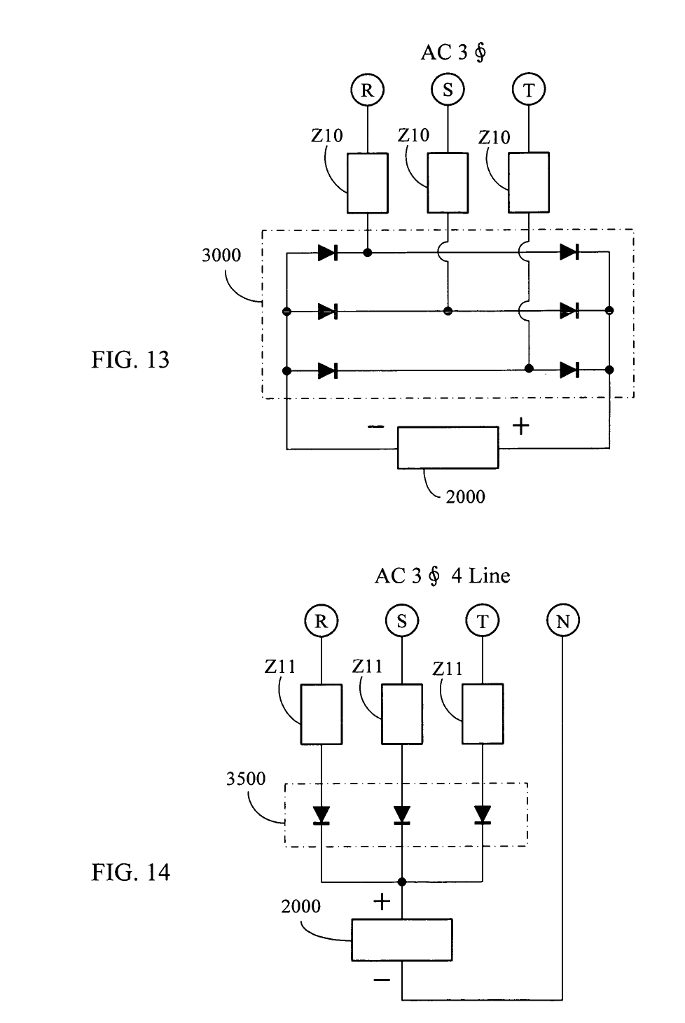

FIG. 13 is the circuit diagram showing three phase alternating current power being supplied, through the current limit device (Z10), to the three phase full wave direct current electric energy that had been rectified by the bridge rectifier and then to the direct current electric energy-driven luminous body (2000).

As shown in FIG. 13, this consist of:

The input terminals of three-phase alternating current power—R, S, and T of the three-phase bridge rectifier (3000) are separately connected in series with the current limit impedance device (Z10) and then connect to the three-phase alternating current power. Current limit device (Z10) is consisted of resistor (401) and/or inductor (301) and/or capacitor (201). The direct current electric energy from the direct current output terminal is supplied to the direct current electric energy-driven luminous body (2000).

Electric energy-driven luminous body (2000): Luminous bodies consisting of gas bulbs with filaments, solid state electric energy luminous bodies such as LED and others that accept direct current electric energy drive;

FIG. 14 is the circuit diagram showing the three phase alternating current power passing through the half-wave current limit impedance device (Z11) to the three phase half-wave rectifier (3500) where rectified direct current electric energy is supplied to the direct current electric energy-driven luminous body (2000).

As shown in FIG. 14, this consists of:

The input terminals of three-phase alternating current power—R, S, and T of the three-phase half wave rectifier (3500) are separately connected in series with the half wave current limit impedance device (Z11) and then connect to the three-phase alternating current power. Half wave current limit impedance device (Z11) is consisted of resistor (401) and/or inductor (301) and/or capacitor (201). The direct current electric energy from the direct current output terminal of the three-phase half wave rectifier (3500) is supplied to the direct current electric energy-driven luminous body (2000) while the negative terminal of the direct current electric energy-driven luminous body connects to the neutral line N of the three-phase four wire power.

Direct current electric energy-driven luminous body (2000): Luminous bodies consisting of gas bulbs with filaments, solid state electric energy luminous bodies such as LED and others that accept direct current electric energy drive;

Moreover, if single phase alternating current power is used from at least two of the following: (1) output electric energy from the series connection between the single alternating current power and resistor (401), (2) output electric energy from the series connection between the same single phase alternating current power and capacitor (201) and (3) electric energy from the series connection between the same alternating current power and the inductor (301); and after being rectified by separate rectifiers, jointly drive the direct current electric energy-driven luminous body (2000) in order to improve the pulsation of the projected light energy intensity.

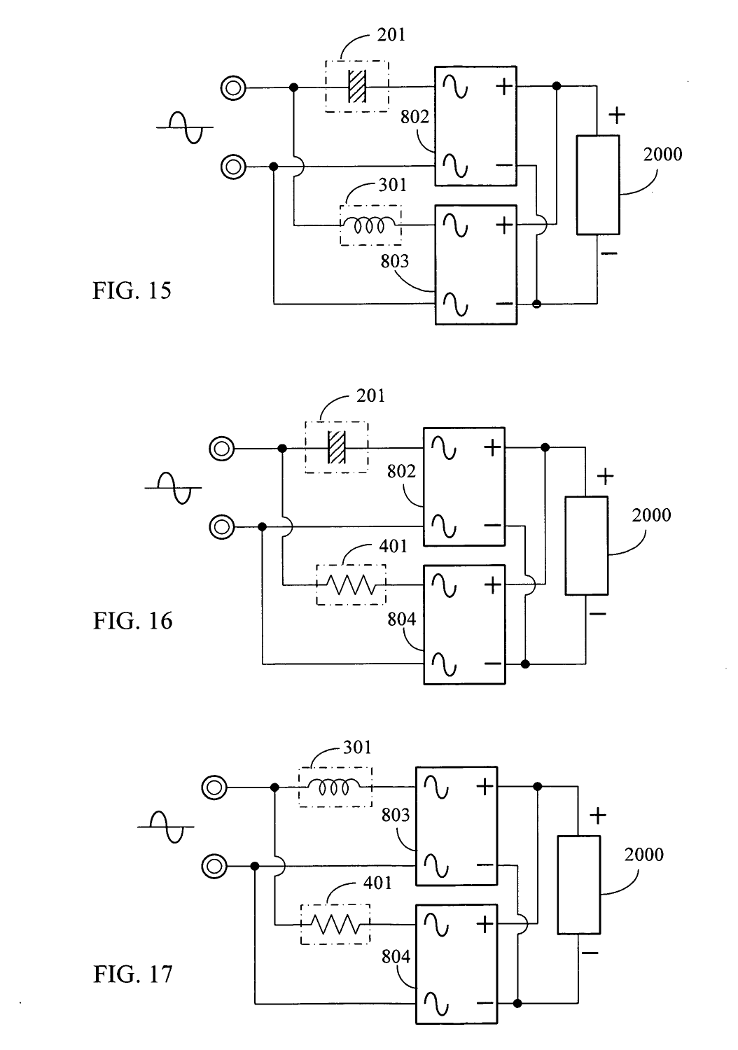

FIG. 15 is the circuit diagram of the capacitor and inductor effecting split phase and then full wave rectification on the single phase power in order to drive the direct current electric energy-driven luminous body (2000).

As shown in FIG. 15, one terminal of the single phase alternating current power is connected to one of the alternating current input terminals of the single phase bridge rectifier (802) through capacitor (201); the same terminal from the same single phase alternating current power is connected to one of the alternating current input terminals of another single phase bridge rectifier (803) through inductor (301); the other terminal of the single phase alternating current power supplies the other alternating current power input terminal of the single phase bridge rectifiers (802) and (803); then the direct current output terminals of the single phase bridge rectifiers (802) and (803) are homopolar connected in parallel in order to drive the direct current electric energy-driven luminous body (2000).

FIG. 16 is the circuit diagram of the capacitor and resistor effecting split phase and then full wave rectification on the single phase power in order to drive the direct current electric energy-driven luminous body (2000).

As shown in FIG. 16, one terminal of the single phase alternating current power is connected to one of the alternating current input terminals of the single phase bridge rectifier (802) through capacitor (201); the same terminal from the same single phase alternating current power is connected to one of the alternating current input terminals of another single phase bridge rectifier (804) through resistor (401); the other terminal of the single phase alternating current power supplies the other alternating current power input terminal of the single phase bridge rectifiers (802) and (804); then the direct current output terminals of the single phase bridge rectifiers (802) and (804) are homopolar connected in parallel in order to drive the direct current electric energy-driven luminous body (2000).

FIG. 17 is the circuit diagram of the inductor and resistor effecting split phase and then full wave rectification on the single phase power in order to drive the direct current electric energy-driven luminous body (2000).

As shown in FIG. 17, one terminal of the single phase alternating current power is connected to one of the alternating current input terminals of the single phase bridge rectifier (803) through inductor (301); the same terminal from the same single phase alternating current power is connected to one of the alternating current input terminals of another single phase bridge rectifier (804) through resistor (401); the other terminal of the single phase alternating current power supplies the other alternating current power input terminal of the single phase bridge rectifiers (803) and (804); then the direct current output terminals of the single phase bridge rectifiers (803) and (804) are homopolar connected in parallel in order to drive the direct current electric energy-driven luminous body (2000).

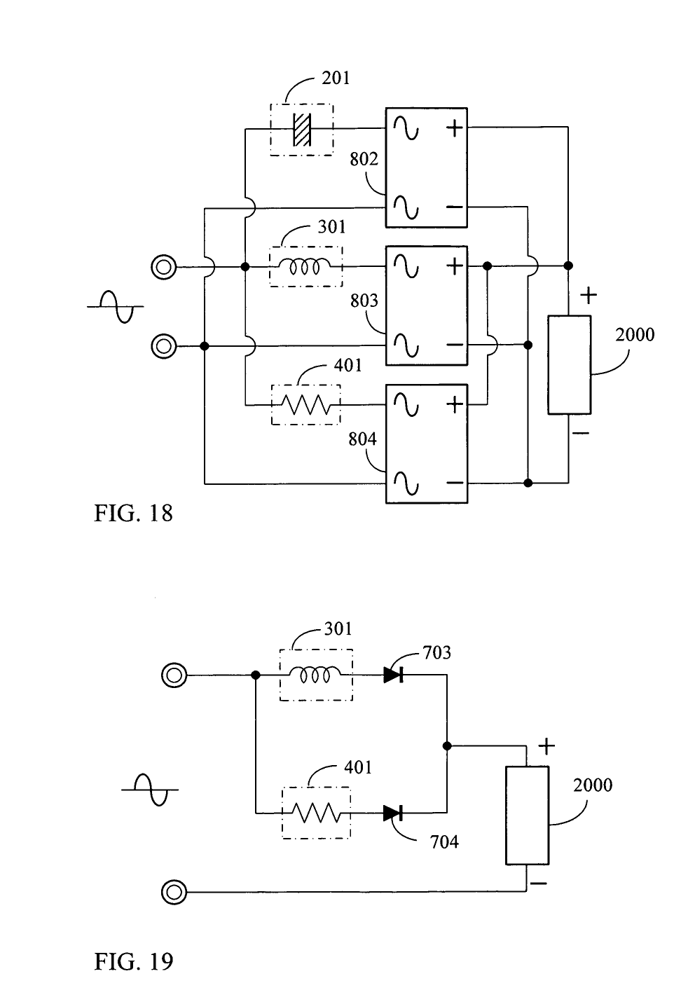

FIG. 18 is the circuit diagram of the inductor, resistor and capacitor effecting split phase and then full wave rectification on the single phase power in order to drive the direct current electric energy-driven luminous body (2000).

As shown in FIG. 18, one terminal of the single phase alternating current power is connected to one of the alternating current input terminals of the single phase bridge rectifier (803) through inductor (301); the same terminal from the same single phase alternating current power is connected to one of the alternating current input terminals of another single phase bridge rectifier (804) through resistor (401); the same terminal of the same single phase alternating current power is connected to one of the alternating input terminals of another single phase bridge rectifier (802) through capacitor (201); the other terminal of the single phase alternating current power supplies the other alternating current power input terminal of the single phase bridge rectifiers (802), (803) and (804); then the direct current output terminals of the single phase bridge rectifiers (802), (803) and (804) are homopolar connected in parallel in order to drive the direct current electric energy-driven luminous body (2000).

FIG. 19 is the circuit diagram of the inductor and resistor effecting split phase and then half wave rectification on the single phase power in order to drive the direct current electric energy-driven luminous body (2000).

As shown in FIG. 19, one terminal of the single phase alternating current power is connected to the alternating current input terminals of the rectifier diode (703) through inductor (301); the same terminal from the same single phase alternating current power is connected to one of the alternating current input terminals of another rectifier diode (704) through resistor (401); the other terminal of the single phase alternating current power is connected to the negative terminal of the direct current electric energy-driven luminous body (2000); then the direct current output positive terminals of the rectifier diodes (703) and (704) are homopolar connected in parallel in order to drive the direct current electric energy-driven luminous body (2000).

1. A Lighting Device with Optical Pulsation Suppression by Polyphase-Driven Electric Energy relies on polyphase alternating current power with phase difference or direct current power rectified from polyphase alternating current power to drive a common electric energy-driven luminous body; or to separately drive proximately installed individual electric energy-driven luminous bodies so that the pulsation of the outwardly projected light is reduced.

2. The Lighting Device with Optical Pulsation Suppression by Polyphase-Driven Electric Energy of claim 1, includes an electric energy-driven luminous body individually driven by single phase power in three ways through inductor split-phase current, capacitor split-phase current and the resultant vector current of the inductor and capacitor split-phase current:
the terminals (1011), (1021), and (1031) of the electric energy-driven luminous bodies (101), (102) and (103) driven by bidirectional electric energy are connected together. Terminal (1022) of the electric energy-driven luminous body (102) is connected to terminal (2011) of capacitor (201); terminal (1032) of electric energy-driven luminous body (103) is connected to terminal (3011) of the inductor (301); terminal (2012) of the capacitor (201) is connected to terminal (3012) of the inductor (301) after which it goes to a terminal of an alternating current or bidirectional electric energy; terminal (1012) of electric energy-driven luminous body (101) is then connected to the other terminal of the alternating current or bidirectional electric energy; thereinto the current (I101) that passes through electric energy-driven luminous body (101) is the vector sum of the current (I102) that passes through electric energy-driven luminous body (102) and current (I103) of electric energy-driven luminous body (103) which is also the total current;
Electric energy-driven luminous bodies (101), (102),(103): Are three luminous bodies integrated into one body or three proximately installed bodies consisting of gas bulbs with filaments, solid state electric energy luminous bodies such as LED and others that accept electric energy drive.

3. The Lighting Device with Optical Pulsation Suppression by Polyphase-Driven Electric Energy of claim 2, includes the positions of the capacitor (201) in the circuit and the electric energy-driven luminous body (102), and/or the interchanging of the positions of the inductor (301) and the electric energy-driven luminous body (103), wherein:
Terminal (1011) of electric energy-driven luminous body (101), terminal (2011) of capacitor (201) and terminal (3011) of inductor (301) are connected together; the other terminal (2012) of capacitor (201) is connected to terminal (1021) of electric energy-driven luminous body (102); the other terminal (3012) of the inductor (301) is connected to terminal (1031) of the electric energy-driven luminous body (103); the other terminal (1022) of electric energy-driven luminous body (102) is connected to terminal (1032) of the electric energy-driven luminous body (103) afterwhich it goes to a terminal of a power source; the other terminal (1012) of the electric energy-driven luminous body (101) is connected to the other terminal of the power source;
Electric energy-driven luminous bodies (101), (102), (103): Are three luminous bodies integrated into one body or three proximately installed bodies consisting of gas bulbs with filaments, solid state electric energy luminous bodies such as LED and others that accept electric energy drive;
Moreover, if series capacitor (201) or one of the electric energy-driven luminous bodies of inductor (301) is directly connected in parallel with electric energy-driven luminous body (101), or in parallel with the electric energy-driven luminous body (101) of the series resistor, then the pulsation of the projected light energy are also improved.

4. The Lighting Device with Optical Pulsation Suppression by Polyphase-Driven Electric Energy of claim 1, includes the alternating current power in parallel with: the capacitor (201) which is in series with the electric energy-driven luminous body (102), the inductor (301) which is in series with the electric energy-driven luminous body (103), and directly with the electric energy-driven luminous body (101) or the resistor (401) which is in series with the electric energy-driven luminous body (101).

5. The Lighting Device with Optical Pulsation Suppression by Polyphase-Driven Electric Energy of claim 1, includes the capacitor (201) in series with the electric energy-driven luminous body (102) and connected in parallel directly with the electric energy-driven luminous body (101) or with the electric energy-driven luminous body (101) in series with the resistor (401) in order to accept alternating current or bidirectional power drive.

6. The Lighting Device with Optical Pulsation Suppression by Polyphase-Driven Electric Energy of claim 1, includes the inductor (301) in series with the electric energy-driven luminous body (103) and connected in parallel directly with the electric energy-driven luminous body (101) or with the electric energy-driven luminous body (101) in series with the resistor (401) in order to accept alternating current or bidirectional power drive.

7. The Lighting Device with Optical Pulsation Suppression by Polyphase-Driven Electric Energy of claim 1, includes the capacitor (201) in series with the electric energy-driven luminous body (102) and connected in parallel with the electric energy-driven luminous body (103) in series with the inductor (301) in order to accept alternating current or bidirectional power drive.

8. The Lighting Device with Optical Pulsation Suppression by Polyphase-Driven Electric Energy of claim 1, includes the use of three-phase alternating current power to deliver electricity to the electric energy-driven luminous body in order to reduce the pulsation of the luminous brightness; wherein the three-phase four-wire alternating current power is driving three sets of electric energy-driven luminous bodies in Y connection; this consists of:
Electric energy-driven luminous body (101) which is directly connected or in series with the resistive and/or capacitive and/or inductive impedance device (1000) after which one terminal connects to a three-phase power line R, while the other terminal goes to a common Y connection point;
Electric energy-driven luminous body (102) which is directly connected or in series with the resistive and/or capacitive and/or inductive impedance device (1000) afterwhich one terminal connects to a three-phase power line S, while the other terminal goes to a common Y connection point;
Electric energy-driven luminous body (103) which is directly connected or in series with the resistive and/or capacitive and/or inductive impedance device (1000) afterwhich one terminal connects to a three-phase power line T, while the other terminal goes to a common Y connection point.

9. The Lighting Device with Optical Pulsation Suppression by Polyphase-Driven Electric Energy of claim 1, includes the use of three-phase alternating current power to deliver electricity to the electric energy-driven luminous body in order to reduce the pulsation of the luminous brightness; wherein the three-phase alternating current power is driving three sets of electric energy-driven luminous bodies in A connection; this consists of:
Electric energy-driven luminous body (101) which is directly connected or in series with the resistive and/or capacitive and/or inductive impedance device (1000), and then in parallel between power line R and power line S;
Electric energy-driven luminous body (102) which is directly connected or in series with the resistive and/or capacitive and/or inductive impedance device (1000), and then in parallel between power line S and power line T;
Electric energy-driven luminous body (103) which is directly connected or in series with the resistive and/or capacitive and/or inductive impedance device (1000), and then in parallel between power line T and power line R.

10. The Lighting Device with Optical Pulsation Suppression by Polyphase-Driven Electric Energy of claim 1, includes the use of three-phase alternating current power to deliver electricity to the electric energy-driven luminous body in order to reduce the pulsation of the luminous brightness; wherein the three-phase alternating current power is driving two sets of electric energy-driven luminous bodies in V connection; this consists of:
Electric energy-driven luminous body (101) which is directly connected or in series with the resistive and/or capacitive and/or inductive impedance device (1000), and then in parallel between power line R and power line S;
Electric energy-driven luminous body (102) which is directly connected or in series with the resistive and/or capacitive and/or inductive impedance device (1000), and then in parallel between power line S and power line T.

11. The Lighting Device with Optical Pulsation Suppression by Polyphase-Driven Electric Energy of claim 1, includes the use of three-phase alternating current power to deliver electricity to the electric energy-driven luminous body in order to reduce the pulsation of the luminous brightness; wherein the three-phase alternating current power is driving two sets of electric energy-driven luminous bodies in V connection; this consists of:
Electric energy-driven luminous body (101) which is in series with electric energy-driven luminous body (102), and then in parallel between power line R and power line T;
The power line S, after connecting in series with a resistive and/or capacitive and/or inductive impedance device (1000), is then connected to the series connection point of electric energy-driven luminous body (101) and electric energy-driven luminous body (102).

12. The Lighting Device with Optical Pulsation Suppression by Polyphase-Driven Electric Energy of claim 11, wherein that consists of direct current power rectified from polyphase alternating current power to drive a common electric energy-driven luminous body or to separately drive proximately installed individual electric energy-driven luminous bodies in order to reduce the pulsation of outwardly projected light; wherein a three-phase alternating current power is delivered through the current limit device (Z10) to the direct current power after being rectified by the three-phase full wave bridge rectifier for delivery to the direct current electric energy-driven luminous body (2000); this consists of:
The input terminals of three-phase alternating current power—R, S, and T of the three-phase bridge rectifier (3000) are separately connected in series with the current limit impedance device (Z10) and then connect to the three-phase alternating current power. Current limit device (Z10) is consisted of resistor (401) and/or inductor (301) and/or capacitor (201); the direct current electric energy from the direct current output terminal is supplied to the direct current electric energy-driven luminous body (2000);
Electric energy-driven luminous body (2000): Luminous bodies consisting of gas bulbs with filaments, solid state electric energy luminous bodies such as LED and others that accept direct current electric energy drive.

13. The Lighting Device with Optical Pulsation Suppression by Polyphase-Driven Electric Energy of claim 1, wherein that consists of direct current power rectified from polyphase alternating current power to drive a common electric energy-driven luminous body or to separately drive proximately installed individual electric energy-driven luminous bodies in order to reduce the pulsation of outwardly projected light; wherein a three-phase alternating current power is delivered through the half wave current limit impedance device (Z11) to the direct current power after being rectified by a three-phase half wave rectifier (3500) for delivery to the direct current electric energy-driven luminous body (2000); this consists of: The input terminals of three-phase alternating current power—R, S, and T of the three-phase half wave rectifier (3500) are separately connected in series with the half wave current limit impedance device (Z11) and then connect to the three-phase alternating current power. Half wave current limit impedance device (Z11) is consisted of resistor (401) and/or inductor (301) and/or capacitor (201); the direct current electric energy from the direct current output terminal of the three-phase half wave rectifier (3500) is supplied to the direct current electric energy-driven luminous body (2000) while the negative terminal of the direct current electric energy-driven luminous body connects to the neutral line N of the three-phase four wire power;
Direct current electric energy-driven luminous body (2000): Luminous bodies consisting of gas bulbs with filaments, solid state electric energy luminous bodies such as LED and others that accept direct current electric energy drive.

14. The Lighting Device with Optical Pulsation Suppression by Polyphase-Driven Electric Energy of claim 1, wherein the single phase alternating current power is used from at least two of the following: 1) output electric energy from the series connection between the single alternating current power and resistor (401), 2) output electric energy from the series connection between the same single phase alternating current power and capacitor (201) and 3) electric energy from the series connection between the same alternating current power and the inductor (301); and after being rectified by separate rectifiers, jointly drive the direct current electric energy-driven luminous body (2000) in order to improve the pulsation of the projected light energy intensity.

15. The Lighting Device with Optical Pulsation Suppression by Polyphase-Driven Electric Energy of claim 1, includes the capacitor and the inductor effecting a split phase and then a full wave rectification on the single phase power in order to drive the electric energy-driven luminous body (2000); wherein: one terminal of the single phase alternating current power is connected to one of the alternating current input terminals of the single phase bridge rectifier (802) through capacitor (201); the same terminal from the same single phase alternating current power is connected to one of the alternating current input terminals of another single phase bridge rectifier (803) through inductor (301); the other terminal of the single phase alternating current power supplies the other alternating current power input terminal of the single phase bridge rectifiers (802) and (803); then the direct current output terminals of the single phase bridge rectifiers (802) and (803) are homopolar connected in parallel in order to drive the direct current electric energy-driven luminous body (2000).

16. The Lighting Device with Optical Pulsation Suppression by Polyphase-Driven Electric Energy of claim 1, includes the capacitor and the resistor effecting a split phase and then a full wave rectification on the single phase power in order to drive the electric energy-driven luminous body (2000); wherein: one terminal of the single phase alternating current power is connected to one of the alternating current input terminals of the single phase bridge rectifier (802) through capacitor (201); the same terminal from the same single phase alternating current power is connected to one of the alternating current input terminals of another single phase bridge rectifier (804) through resistor (401); the other terminal of the single phase alternating current power supplies the other alternating current power input terminal of the single phase bridge rectifiers (802) and (804); then the direct current output terminals of the single phase bridge rectifiers (802) and (804) are homopolar connected in parallel in order to drive the direct current electric energy-driven luminous body (2000).

17. The Lighting Device with Optical Pulsation Suppression by Polyphase-Driven Electric Energy of claim 1, includes the inductor and the resistor effecting a split phase and then a full wave rectification on the single phase power in order to drive the electric energy-driven luminous body (2000); wherein: one terminal of the single phase alternating current power is connected to one of the alternating current input terminals of the single phase bridge rectifier (803) through inductor (301); the same terminal from the same single phase alternating current power is connected to one of the alternating current input terminals of another single phase bridge rectifier (804) through resistor (401); the other terminal of the single phase alternating current power supplies the other alternating current power input terminal of the single phase bridge rectifiers (803) and (804); then the direct current output terminals of the single phase bridge rectifiers (803) and (804) are homopolar connected in parallel in order to drive the direct current electric energy-driven luminous body (2000).

18. The Lighting Device with Optical Pulsation Suppression by Polyphase-Driven Electric Energy of claim 1, includes the inductor, capacitor and the resistor effecting a split phase and then a full wave rectification on the single phase power in order to drive the electric energy-driven luminous body (2000); wherein: one terminal of the single phase alternating current power is connected to one of the alternating current input terminals of the single phase bridge rectifier (803) through inductor (301); the same terminal from the same single phase alternating current power is connected to one of the alternating current input terminals of another single phase bridge rectifier (804) through resistor (401); the same terminal of the same single phase alternating current power is connected to one of the alternating input terminals of another single phase bridge rectifier (802) through capacitor (201); the other terminal of the single phase alternating current power supplies the other alternating current power input terminal of the single phase bridge rectifiers (802), (803) and (804); then the direct current output terminals of the single phase bridge rectifiers (802), (803) and (804) are homopolar connected in parallel in order to drive the direct current electric energy-driven luminous body (2000).

19. The Lighting Device with Optical Pulsation Suppression by Polyphase-Driven Electric Energy of claim 1, includes the inductor and the resistor effecting a split phase and then a half wave rectification on the single phase power in order to drive the electric energy-driven luminous body (1000); wherein: one terminal of the single phase alternating current power is connected to the alternating current input terminals of the rectifier diode (703) through inductor (301); the same terminal from the same single phase alternating current power is connected to one of the alternating current input terminals of another rectifier diode (704) through resistor (401); the other terminal of the single phase alternating current power is connected to the negative terminal of the direct current electric energy-driven luminous body (2000); then the direct current output positive terminals of the rectifier diodes (703) and (704) are homopolar connected in parallel in order to drive the direct current electric energy-driven luminous body (2000).
